(19) United States
(12) Patent Application Publication
(10) Pub. No.: US 2006/0034961 A1
(43) Pub. Date: Feb. 16, 2006

(54) Device for processing plastic waste

(75) Inventors: Franz Starlinger-Huemer, Vienna (AT); Angelika Huemer, Vienna (AT); Markus Fellinger, Wilhering (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Starlinger & Co. G.m.b.H., Vienna (AT)

(21) Appl. No.: 10/521,527

(22) PCT Filed: Mar. 11, 2003
(86) PCT No.: PCT/AT03/00068

§ 371 Date: Aug. 2, 2005

(30) Foreign Application Priority Data
Jul. 18, 2002 (AT) A 1088/2002

(51) Int. Cl. B29C 47/36

(52) U.S. Cl. 425/208

(57) ABSTRACT

A device for the processing of plastic waste, comprising a shredding device (9) arranged in a casing (1) and rotatable around an axis of rotation (2), which shredding device carries a plurality of knives (3) at its periphery, and an extruder comprising an extruder screw (4), with the casing (1) comprising a feed opening (5) for the supply of plastic waste to the shredding device (9) and a discharge opening (6) for the delivery of shredded plastic waste to the extruder. The shredding device (9) and its knives (3), respectively, can be moved past the extruder screw (4) at such a small distance (h) that effective shear gaps are formed between the knives (3) of the shredding device (9) and a helix (4a) of the extruder screw (4).

The invention relates to a device for the processing of plastic waste, comprising a shredding device arranged in a casing and rotatable around an axis of rotation, which shredding device carries a plurality of knives at its periphery, and an extruder comprising an extruder screw, with the casing comprising a feed opening for the supply of plastic waste to the shredding device and a discharge opening for the delivery of shredded plastic waste to the extruder, according to the preamble of claim 1.

When processing plastic waste in such devices, the uniform charging of the extruder with already precompressed material involves great difficulties.

In order to overcome this problem, in conventional recycling machines, the material to be processed is shredded at first by a grinder with an attached punched screen and is then supplied to an extruder, optionally via a buffer storage bin and a low-cut plug screw. This arrangement has the drawback that, apart from the space-consuming and expensive design, the pre-shredding energy developed in the shredding implement is lost.

From EP 0123771, a device is known wherein a rapidly rotating tool revolving on a container base is used for shredding plastic waste, the shredded waste being pressed into the extruder screw by the centrifugal force exerted by the rotation of the tool. With plastic waste having a relatively high bulk density of more than appx. 0.4 kg/dm³, said device operates satisfactorily; with lighter waste such as, for instance, thin films, it is, however, often impossible to achieve sufficient charging of the extruder screw, or such is only possible if, via the emerging frictional heat, the synthetic materials in the processing cylinder are heated to the agglomeration temperature, hence the bulk density increases and consequently the centrifugal force grows. However, even if the temperatures are only slightly above the agglomeration temperature, the synthetic material provided in the processing cylinder will be melted, which in turn leads to an overload of the drive motor.

Another technological approach consists in that primarily film waste in its unshredded form is directly fed into an extruder screw having a diameter that is widened in its feed area, which extruder screw subsequently converges conically in the screw root or in the diameter, viewed in the direction of the material flow. Said embodiment involves the disadvantage that, in the feed area, the extruder screw exerts only a small amount of wall friction on the loose synthetic material due to the low bulk density of the material and hence a corotation of the material in the feed area is likely, preventing the material from advancing, which results in a “pumping” action of the extruder. In particular if said device is charged with unshredded edge trim waste whose delivery speed is higher than the peripheral speed of the screw, the result will be an irregular charging of the extruder.

From WO 9816360, a device is known wherein the loose synthetic material is cut by means of a shredder shaft and compressed via a feed screw located on the shaft, before a tangentially flanged extruder is filled. However, said device has the disadvantage that the material is always conveyed in the direction of the discharge-end bearing, the deflection thus leading to an increase in thermal degradation and hence to an increase in the bearing load. In an embodiment illustrated in said document, the extruder is charged via two counter-rotating feed screws provided on one shaft, with the extruder being located in the centre between the screws. Said device involves the drawback that the synthetic material has to be pre-shredded.

Furthermore, devices are known which have a shredder shaft that operates in parallel to the extruder screw and feeds material into the screw. Since the shredder shaft is arranged in parallel to the extruder and hence the extruder shaft must be expanded by the width of the shredding device, the space required by said device is very large.

The present invention attempts to eliminate the above-described disadvantages of the known machines by advancing the initially mentioned device such that the shredding device is arranged at such a small distance from the extruder screw that effective shear gaps are formed between the knives of the shredding device and a helix of the extruder screw.

Through the shear gaps formed between the knives and the extruder-screw helix, on the one hand, plastic parts that have already been shredded sufficiently are pressed into the extruder, on the other hand, however, larger material parts that have not yet been sufficiently shredded and might plug the feed area of the extruder are either shredded directly in the shear gaps or are returned to the area between the inner wall of the casing and the rotating shredding device, whereby they are subjected to renewed shredding. Furthermore, the formation of bridges or channels of material is effectively prevented.

The actual distance between the knives and the extruder-screw helix depends on the type of synthetic material to be processed, in particular on its bulk density, and may be the larger, the higher the bulk density. In general, said distance is chosen such that it amounts to less than 10 cm, preferably less than 5 cm, and most preferably less than 3 cm. The latter value is suitable in particular for the size reduction of film waste and thin plastic strips.

In order to achieve a short compact design, in a preferred embodiment of the invention, the axis of rotation of the rotatable shredding device is disposed relative to the rotational axis of the extruder screw at an angle of 60-120°, preferably at about a right angle. Furthermore, it proves to be beneficial if the shredding device has a horizontal axis of rotation and is arranged above the extruder. In such a design, the shredded synthetic material falls, due to its own weight, through the discharge opening onto the extruder screw.

In order to support the conveyance of the synthetic material toward the discharge opening, the knives disposed around the periphery of the shredding device should be arranged in a helical manner. According to the invention, devices for supporting the conveyance of material toward the discharge opening, in particular helical grooves or webs and/or air nozzles, can in addition be provided at the inner wall of the casing, which wall surrounds the shredding device.

A particularly preferred embodiment of the invention is characterized in that the discharge opening is arranged roughly at the mid-point of the length of the shredding device. By that measure, together with the support of the conveyance of synthetic material toward the discharge opening by means of helically arranged knives, grooves or webs and/or air nozzles, the material is carried away from the pivot bearings situated at the ends of the shredding device so that—in contrast to the prior art—the pressure applied by the synthetic material to the bearing points is very low. Furthermore, said measure has the effect that no synthetic material can enter the bearings.

In order to operate the device according to the invention for the processing of plastic waste in the best possible way and in order to prevent overload or idle running, the rotational speed of the extruder screw can be adjusted depending on the load of the shredding device, wherein the load can preferably be determined via pressure elements or the electric current consumption of a drive motor of the shredding device.

Optionally, a pocket-like expansion can furthermore be provided as a buffer storage for shredded plastic waste in the feed area of the extruder screw.

In order to achieve a further improvement of the material supply and size reduction, a driven slide can be provided, which cooperates with the shredding device in order to press the synthetic material against the knives, depending on the load on the axis of rotation of the shredding device.

Excellent material feed can be obtained if the extruder screw is widened to a larger diameter in the feed area and/or tapers conically toward the material-discharge end.

In some cases, it is desired for the processing device to exhibit a slim overall design. For that purpose, the axis of rotation of the shredding device is arranged in parallel to the axis of the extruder screw.

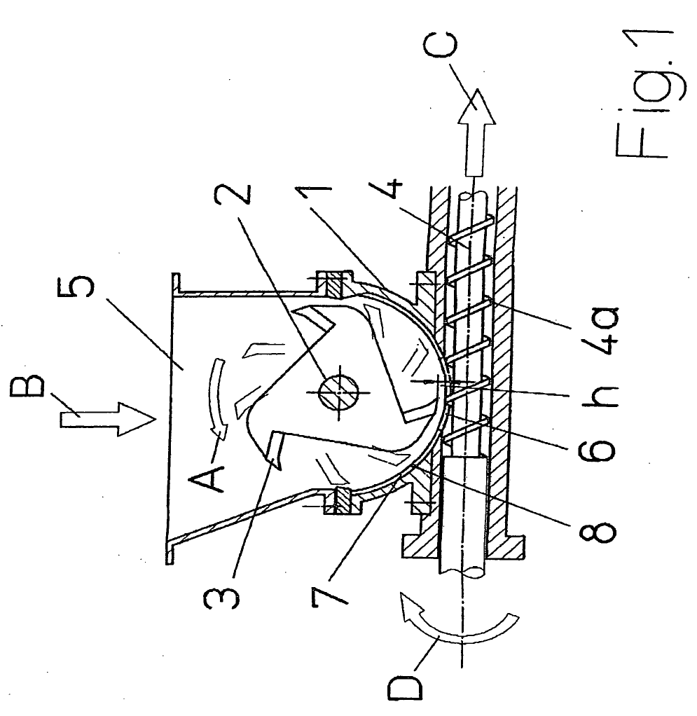

FIG. 1 shows a first embodiment of the device according to the invention for the processing of synthetic materials in longitudinal section,

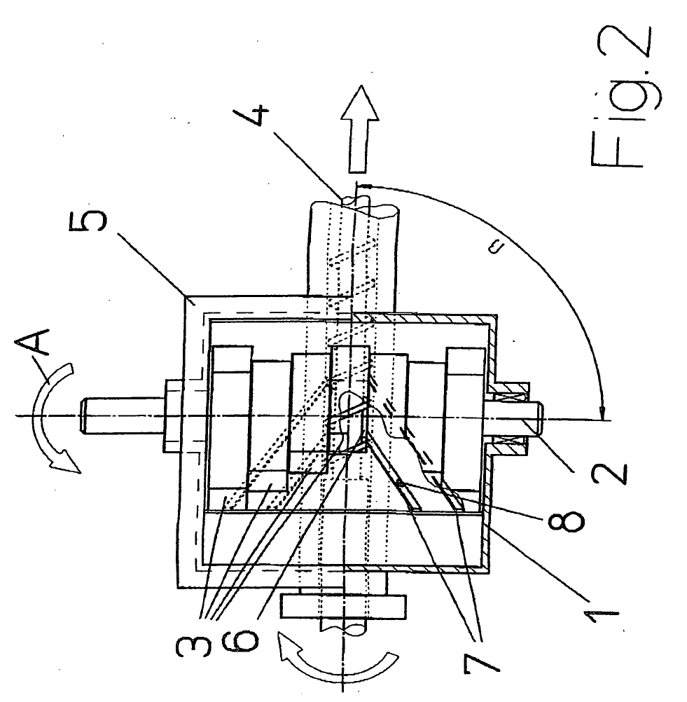

FIG. 2 illustrates the same device in a partially sectional top view;

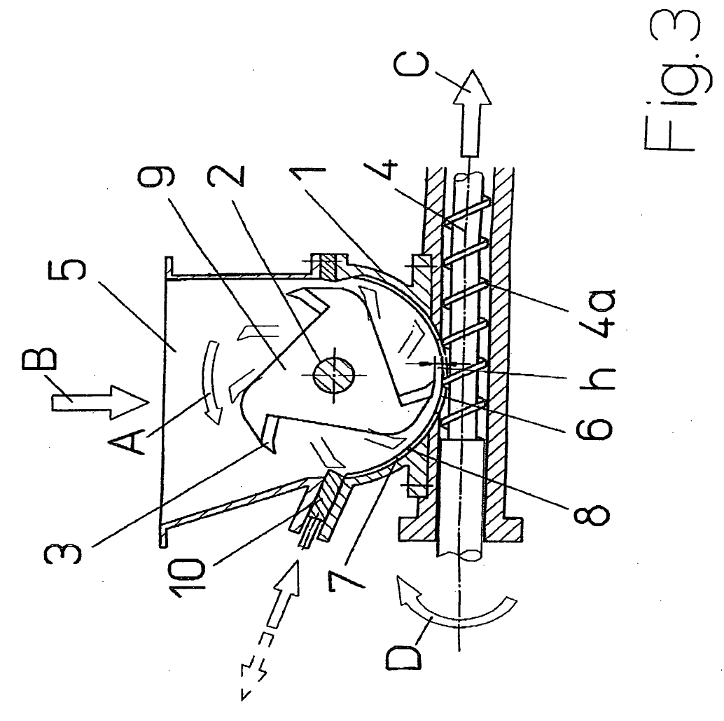

FIG. 3 shows a second embodiment of a device according to the invention in longitudinal section.

With reference to FIGS. 1 and 2, a first embodiment of the invention is now exemplified. A device for the processing of plastic waste is shown, comprising a shredding device 9 arranged in a casing 1 and rotatable around an axis of rotation 2 (arrow A), which shredding device carries a plurality of knives 3 at its periphery. The shredding device 9 is located above an extruder comprising an extruder screw 4 and a screw helix 4a, with the screw 4 being rotatable in the direction of arrow D and discharging the extruded synthetic material in the direction of arrow C. The casing 1 is provided with a feed opening 5 for the supply (arrow B) of plastic waste to the shredding device 9 and a discharge opening 6 for the delivery of shredded plastic waste to the extruder. According to the invention, the shredding device 9 and its knives 3, respectively, can be moved past the extruder screw 4 at such a small distance h that effective shear gaps are formed between the knives 3 of the shredding device 9 and the helix 4a of the extruder screw 4. Through the shear gaps formed between the knives 3 and the extruder-screw helix 4a, on the one hand, plastic parts that have already been shredded sufficiently are pressed into the extruder, on the other hand, however, material parts that have not yet been sufficiently shredded and might plug the discharge opening 6 or the feed area of the extruder are either shredded directly in the shear gaps or are returned to the area between the inner wall of the casing and the rotating shredding device 9, whereby they are subjected to renewed shredding. The distance h between the knives 3 of the shredding device and the extruder-screw helix 4a, i.e., the width of the shear gap, amounts to less than 10 cm, preferably less than 3 cm, depending on the supplied material.

The axis of rotation 2 of the rotatable shredding device 9 is arranged relative to the rotational axis of the extruder screw 4 at an angle β of 90°, with both the axis of rotation 2 and the extruder screw 4 being on a horizontal line. The knives 3 disposed at the periphery of the shredding device are arranged in a helical manner (see FIG. 2) so as to support the conveyance of synthetic material toward the discharge opening 6. Furthermore, the discharge opening 6 is situated at roughly half-length of the shredding device 9, whereby, due to the opposite rotational direction of the helix arrangement of the knives 3, the material is carried away from the pivot bearings situated at the ends of the shredding device and hence the pressure applied by the synthetic material to the bearing points is reduced. Furthermore, said measure has the effect that no synthetic material can enter the bearings. Helical webs 7 and air nozzles 8 are provided for supporting the conveyance of material toward the discharge opening 6. Preferably, the rotational speed of the extruder screw 4 is adjusted depending on the load of the shredding device 9.

In FIG. 3, a further embodiment of the invention is illustrated, which differs from the device according to FIGS. 1 and 2 only in that the shredding device 9 cooperates with a driven slide 10 which presses the synthetic material against the knives 3, depending on the load on the axis of rotation 2 of the shredding device. With regard to the illustration of the other parts, reference is made to the above description, wherein the same reference numerals have been used for characterization purposes.

Possible variants of the above-described embodiments concern the shape of the extruder screw which may be widened to a larger diameter, for example, in the feed area and/or tapers conically toward the material-discharge end. It is also suitable to provide a pocket-like expansion as a buffer storage for shredded plastic waste in the feed area of the extruder screw. In order to achieve a slim design, the axis of rotation of the shredding device can be arranged in parallel to the axis of the extruder screw.

1. A device for the processing of plastic waste, comprising a shredding device (9) arranged in a casing (1) and rotatable around an axis of rotation (2), which shredding device carries a plurality of knives (3) at its periphery, and an extruder comprising an extruder screw (4), with the casing (1) comprising a feed opening (5) for the supply of plastic waste to the shredding device (9) and a discharge opening (6) for the delivery of shredded plastic waste to the extruder, characterized in that the shredding device (9) and its knives (3), respectively, can be moved past the extruder screw (4) at such a small distance (h) that effective shear gaps are formed between the knives (3) of the shredding device (9) and a helix (4a) of the extruder screw (4).

2. A device for the processing of plastic waste according to claim 1, characterized in that the distance (h) between the knives (3) of the shredding device and the extruder-screw helix (4a) amounts to less than 10 cm, preferably less than 5 cm, and most preferably less than 3 cm.

3. A device for the processing of plastic waste according to claim 1, characterized in that the axis of rotation (2) of the rotatable shredding device (9) is disposed relative to the rotational axis of the extruder screw (4) at an angle (β) of 60-120°, preferably at about a right angle.

4. A device for the processing of plastic waste according to claim 1, characterized in that the shredding device (9) has a horizontal axis of rotation (2) and is arranged above the extruder.

5. A device for the processing of plastic waste according to claim 1, characterized in that the knives (3) disposed around the periphery of the shredding device are arranged in a helical manner so that they support the conveyance of synthetic material toward the discharge opening (6).

6. A device for the processing of plastic waste according to claim 1, characterized in that devices for supporting the conveyance of material toward the discharge opening (6), in particular helical grooves or webs (7) and/or air nozzles (8), are provided at the inner wall of the casing (1), which wall surrounds the shredding device.

7. A device for the processing of plastic waste according to claim 5, characterized in that the discharge opening (6) is arranged roughly at the mid-point of the length of the shredding device (9).

8. A device for the processing of plastic waste according to claim 1, characterized in that the rotational speed of the extruder screw (4) can be adjusted depending on the load of the shredding device (9), wherein the load can preferably be determined via pressure elements or the electric current consumption of a drive motor of the shredding device.

9. A device for the processing of plastic waste according to claim 1, characterized in that a pocket-like expansion is provided as a buffer storage for shredded plastic waste in the feed area of the extruder screw.

10. A device for the processing of plastic waste according to claim 1, characterized in that the shredding device (9) cooperates with a driven slide (10) in order to press the synthetic material against the knives (3), depending on the load on the axis of rotation (2) of the shredding device.

11. A device for the processing of plastic waste according to claim 1, characterized in that the extruder screw is widened to a larger diameter in the feed area and/or tapers conically toward the material-discharge end.

12. A device for the processing of plastic waste according to claim 1, characterized in that the axis of rotation (2) of the shredding device (9) runs in parallel to the axis of the extruder screw (4).
